(19) United States
(12) Patent Application Publication
(10) Pub. No.: US 2011/0012288 A1
(43) Pub. Date: Jan. 20, 2011

(54) Movable Pallet and Method of Use

(76) Inventors: Joseph Gallione, Naperville, IL (US); Richard Wehrli, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 12/836,402

(22) Filed: Jul. 14, 2010

Related U.S. Application Data
(60) Provisional application No. 61/225,557, filed on Jul. 14, 2009.

(51) Int. Cl. B29C 39/10

(52) U.S. Cl. 264/229; 425/253

(57) ABSTRACT

A movable pallet is used in the fabrication of concrete products. The movable pallet comprises a bottom panel including an upper surface and a first gate disposed at a first end of the bottom panel. The first gate is configured to be movable between a first position, in which the first gate extends vertically relative to the upper surface of the bottom panel, and a second position, in which the first gate extends away from the first end of the bottom panel. A corresponding method for fabricating a pre-stressed concrete product comprises: (a) securing a strand to a first gate, (b) extending the strand through a form configured to receive concrete, (c) elongating the strand, (d) securing the strand to a second gate, and (e) providing concrete into the form.

### CROSS-REFERENCE TO RELATED APPLICATIONS/INCORPORATION BY REFERENCE

This application claims priority to U.S. Provisional Application No. 61/225,557 filed Jul. 14, 2009, entitled “MOVABLE PALLET AND METHOD OF USE,” which application is incorporated by reference herein in its entirety.

### FIELD OF THE INVENTION

Embodiments of the present technology generally relate to the manufacture of concrete products. Certain embodiments of the present technology relate to movable pallets and methods of use during the manufacture of pre-stressed concrete products.

### BACKGROUND OF THE INVENTION

Pre-stressed concrete products can be used in the construction of homes and/or other structures, for example. Such products can include tensioned strands that can reinforce the concrete. Pre-stressed concrete products can be fabricated by providing materials in forms and allowing the materials to cure.

Certain known systems and methods relating to the manufacture of pre-stressed concrete products are described, for example, in:

Seppanen et al. U.S. Pat. No. 6,841,110 issued on Jan. 11, 2005;

Longo U.S. Pat. No. 6,773,650 issued on Aug. 10, 2004;

Tadros et al. U.S. Pat. No. 6,668,412 issued on Dec. 30, 2003;

Thim U.S. Pat. No. 6,155,810 issued on Dec. 5, 2000;

Manning U.S. Pat. No. 5,976,442 issued on Nov. 2, 1999;

Yokota U.S. Pat. No. 5,342,568 issued on Aug. 30, 1994;

Schuerhoff et al. U.S. Pat. No. 5,114,653 issued on May 19, 1992;

Kitzmiller U.S. Pat. No. 4,953,280 issued on Sep. 4, 1990;

Cazenave et al. U.S. Pat. No. 4,758,393 issued on Jul. 19, 1988;

Grossman U.S. Pat. No. 4,493,177 issued on Jan. 15, 1985;

Borcoman U.S. Pat. No. 4,421,710 issued on Dec. 20, 1983;

Rieve U.S. Pat. No. 4,245,923 issued on Jan. 20, 1981.

Improved systems and methods for use in the manufacture of pre-stressed concrete products that can increase efficiency and/or reduce cost, for example, are desirable.

### SUMMARY OF THE INVENTION

Certain embodiments of the present technology provide systems and methods that can be used during fabrication of concrete products.

In certain embodiments, for example, a movable pallet for use in fabrication of a concrete product can include a gate and a bottom panel that includes an upper surface. The gate can be disposed at an end of the bottom panel. The gate can be movable between a first position and a second position. In the first position, the gate can extend vertically relative to the upper surface of the bottom panel. In the second position, the gate can extend away from the end of the bottom panel.

In certain embodiments, for example, a method for fabricating a pre-stressed concrete product can include: securing a strand to a first gate; extending the strand through a form configured to receive concrete; elongating the strand; securing the strand to a second gate; and providing concrete into the form.

The foregoing summary illustrates examples of embodiments of the present technology. It should be understood, however, that the present invention is not limited to the embodiments described in the summary.

### BRIEF DESCRIPTION OF THE DRAWING(S)

FIG. 1 is a top view of a section of a movable pallet used in accordance with an embodiment of the present technology.

FIG. 2 is an end view of the movable pallet of FIG. 1.

FIG. 3 is a bottom view of the movable pallet of FIG. 1.

FIG. 4 is a side view of a movable pallet and pallet movement system used in accordance with an embodiment of the present technology.

FIG. 5 is an end view of the movable pallet and pallet movement system of FIG. 4.

FIG. 6 is a side view of a component of a movable pallet used in accordance with an embodiment of the present technology.

FIG. 7 is a top view of the component of FIG. 6.

FIG. 8 is a side view of a section of a movable pallet used in accordance with an embodiment of the present technology.

FIG. 9 is a side view of a section of a movable pallet used in accordance with an embodiment of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF PREFERRED EMBODIMENT(S)

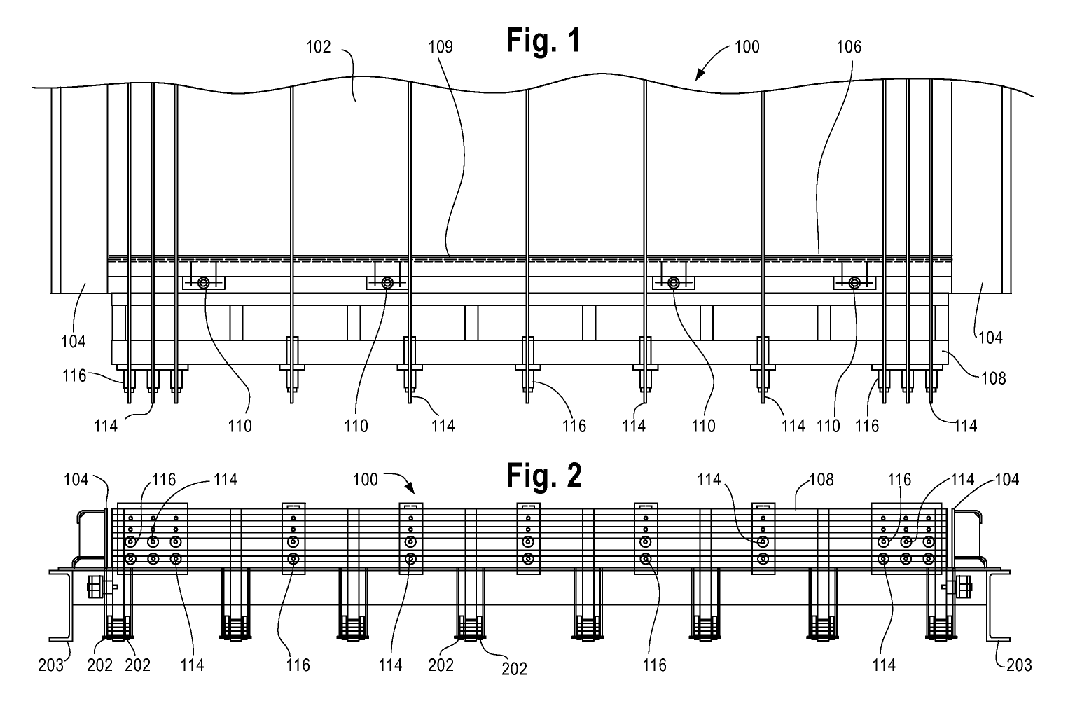

Below is a detailed description of embodiments depicted in FIGS. 1-9. In the figures, like elements are identified with like numerals.

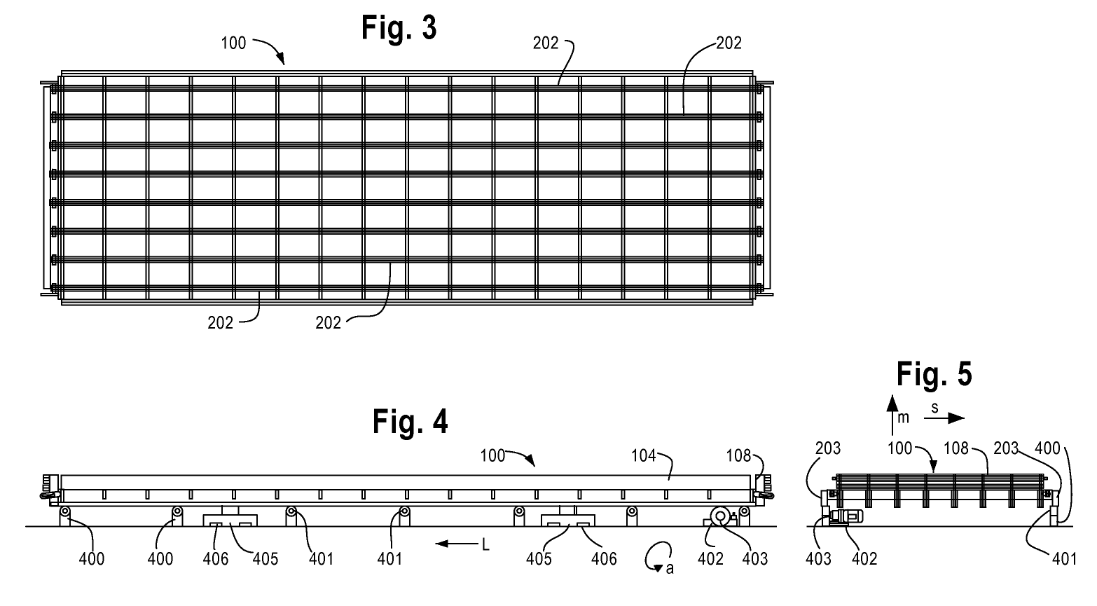

FIG. 1 is a top view of a first end of a movable pallet 100 used in accordance with an embodiment of the present technology. FIG. 2 is an end view of the movable pallet 100 of FIG. 1. FIG. 3 is a bottom view of the movable pallet 100 of FIG. 1. In the embodiment shown in FIG. 1, for example, the pallet 100 includes a bottom panel 102, side panels 104, and end panels 106 that provide a form in which building materials, such as concrete, for example, can be received.

In certain embodiments, for example, the panels 102, 104, 106 can be made of steel and/or other materials with similar properties. In certain embodiments, for example, the bottom panel 102 can provide 40 feet by 12 feet of usable space. In such embodiments, a concrete product that is 40 feet by 12 feet can be fabricated. In certain embodiments, for example, the bottom panel 102 can provide less or more usable space.

In the embodiment shown in FIG. 1, for example, the end panel 106 is movable among a plurality of positions and can be removed completely. The end panel 106 includes a vertical plate 109 and a plurality of magnets 110. The magnets 110 can secure the end panel 106 to the bottom panel 102 in a desired position. In certain embodiments, for example, similarly constructed movable panels can be used on both ends of the pallet 100 and/or on the sides of the pallet 100 to provide a form of any desired length and width. In certain embodiments, for example, such a panel can include one, four, or any other number of magnets in order to secure the panel to the bottom panel 102 in a desired position.

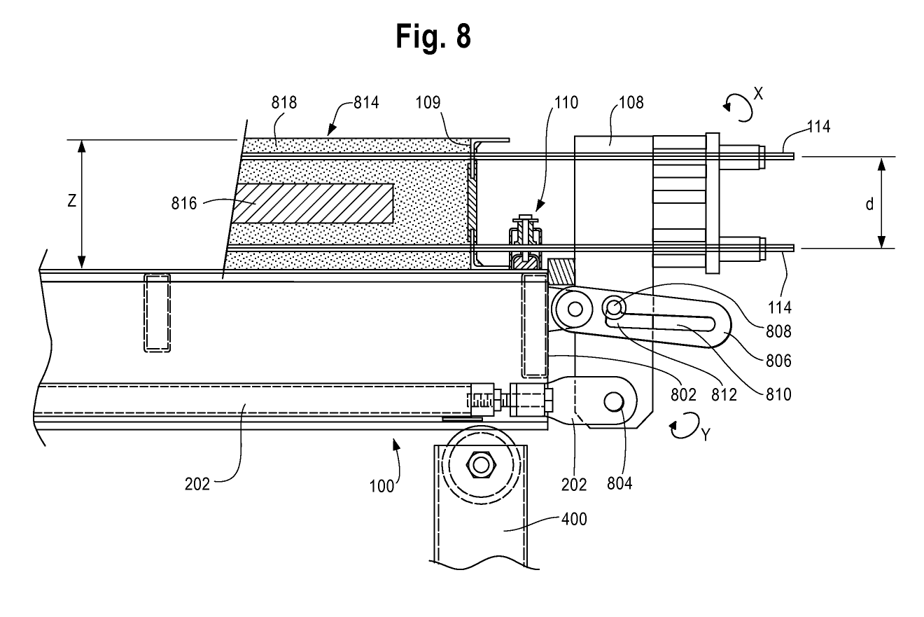

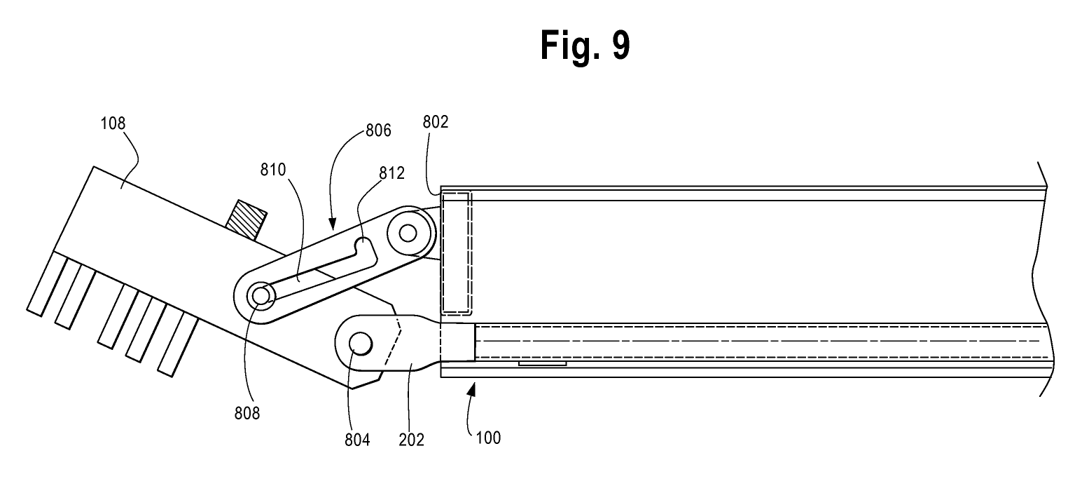

In the embodiment shown in FIG. 1, for example, the pallet 100 also includes a gate 108. The gate 108 is pivotally attached to the pallet 100 such that it can be movable between a first position that is substantially parallel to the vertical plate 109 and a second position wherein the gate 108 extends away from the end of the pallet. An example of such a first position is shown and described in connection with FIG. 8, and an example of such a second position is shown and described in connection with FIG. 9.

In the embodiment shown in FIG. 1, for example, the gate 108 includes a plurality of openings configured to receive metal strands 114. The strands 114 can be inserted through the openings and held in place by chucks 116. The strands 114 can extend across the pallet 100, through corresponding openings in the vertical plate 109 and through the form, and can be secured at the opposite end of the pallet 100 on a second gate using chucks. In certain embodiments, for example, the strands can be a half inch in diameter. In certain embodiments, for example, the strands can have a different diameter.

In certain embodiments, for example, the strands 114 can be tensioned using rams in connection with a hydraulic pump. In such embodiments, the rams can pull the strands 114 away from a first end of the pallet 100 until a desired strand tension is achieved. The ram can release the strands 114, which are then held in place (at the desired tension) by chucks 116 on both ends of the pallet 100. In certain embodiments, a plurality of rams can be used to simultaneously tension a plurality of strands.

In certain embodiments, for example, a strand can be tensioned to 33,000 pounds of tension. In certain embodiments, for example, a strand can be tensioned to a different tension. In certain embodiments, for example, a strand can be over-tensioned. In such embodiments, releasing the strand can result in a drop of tension before the strand is held in place by the chuck. In such embodiments, the amount of over-tensioning can equal the drop in tension that occurs when the ram releases the strand in order to provide the desired tension.

In certain embodiments, for example, up to twenty-two strands can be attached to a pallet. In certain embodiments, for example, a different number of strands can be attached to a pallet. In certain embodiments, such as the embodiment shown in FIG. 2, for example, strands can be positioned in two rows of eleven strands. In certain embodiments, for example, strands can be positioned in different configurations.

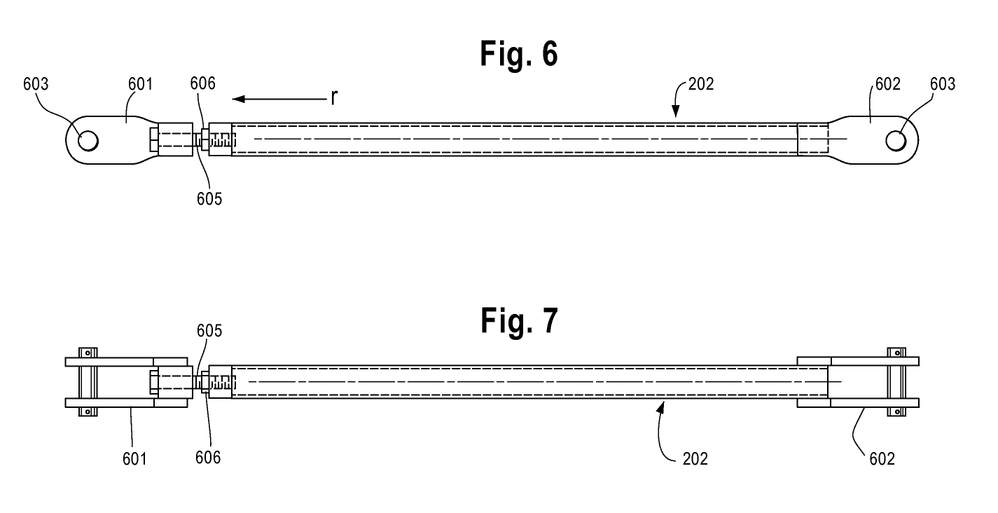

In the embodiment shown in FIG. 1, for example, the pallet 100 also includes a plurality of rods 202 (shown in FIGS. 2 and 3) that extend across the pallet 100 in the same direction as the strands 114. The rods 202 are configured to counteract the forces applied to the pallet 100 by the strands 114 and, in certain embodiments, such as the embodiment shown and described in connection with FIGS. 6 and 7, for example, can be adjustable to provide more or less counteracting forces to the pallet.

In certain embodiments, for example, the rods can be made of steel and/or other material(s) with similar properties. In certain embodiments, such as the embodiment shown in FIG. 3, for example, a pallet can include eight rods. In certain embodiments, for example, a pallet can include a different number of rods.

FIG. 4 is a side view of a movable pallet and pallet movement system used in accordance with an embodiment of the present technology. FIG. 5 is an end view of the movable pallet and pallet movement system of FIG. 4. The pallet movement system includes a plurality of stands 400 with rollers 401 disposed thereon and a motor 402 in mechanical communication with a motorized roller 403. The rollers 401, 403 contact the pallet 100 at roller panels 203 (shown in FIG. 2 as well). When the motor 402 is activated the motorized roller can rotate in direction a, thereby displacing the pallet 100 in the direction L. In certain embodiments, for example, the motor 402 can run in reverse such that the motorized roller 403 rotates in the direction opposite of a, thereby displacing the pallet 100 in the direction opposite of L. In the embodiment shown in FIG. 4, for example, there are seven stands 400 with rollers 401 thereon across the length of the pallet 100. In certain embodiments, for example, there can be more or fewer stands 400 with rollers 401 thereon across the length of a pallet 100.

In the embodiment shown in FIGS. 4 and 5, for example, the pallet movement system also includes lifts 405 and tracks 406. The lifts 405 are configured to contact the roller panels 203 and lift the pallet 100 in the direction m (shown in FIG. 5) such that the roller panels 203 no longer contact the rollers 401, 403. The tracks 406 provide for movement of the lifts 405 in the direction s (shown in FIG. 6) and/or the direction opposite of s. In the embodiment shown in FIGS. 4 and 5, for example, there are two lifts 405. In certain embodiments, for example, there can be more lifts.

In certain embodiments, for example, using lifts and tracks in combination with rollers can provide for movement of a pallet among a plurality of workstations. In certain embodiments, for example, improved mobility can provide increased efficiency and/or reduce costs in a manufacturing environment.

FIG. 6 is a side view of a rod 202 used in accordance with an embodiment of the present technology. FIG. 7 is a top view of the rod 202 of FIG. 6. The rod 202 includes a first end 601 and a second end 602. Both ends 601, 602 include openings 603 configured to receive pins. In certain embodiments, for example, the openings 601, 602 can be configured to receive pins on which a gate of a pallet pivots (as shown, for example, in FIGS. 8 and 9).

In the embodiment shown in FIGS. 6 and 7, for example, the rod 202 is adjustable. The rod 202 includes an externally threaded pin 605 and a corresponding internally threaded bolt 606. The bolt 606 is fixed such that rotating the pin 605 translates the pin 605. In the embodiment shown in FIGS. 6 and 7, for example, rotating the pin 605 in a first direction can translate the pin 605 in a direction r, thereby lengthening the rod 202 and providing less counteracting tension on the pallet. Rotating the pin 605 in a direction opposite the first direction can translate the pin 605 in a direction opposite r, thereby shortening the rod 202 and providing more counteracting tension on the pallet. The counteracting forces of the rods 202 and the strands 114 are described in further detail in connection with FIG. 8. In certain embodiments, for example, other methods of elongating and/or shortening a rod can be used.

FIGS. 8 and 9 are side views of sections of a movable pallet 100 used in accordance with an embodiment of the present technology. The movable pallet 100 includes a gate 108 pivotally attached to the pallet 100 such that it can be movable between a first position that is substantially parallel to the vertical plate 109 and a second position wherein the gate 108 extends away from the end 802 of the pallet 100. An example of such a first position is shown in FIG. 8. An example of such a second position is shown in FIG. 9.

In the embodiment shown in FIGS. 8 and 9, for example, the gate 108 is attached to the pallet 100 using a pin 804, a latch 806 and a notch 808. The pin 804 is provided through openings 603 in the rods 202 (shown, for example in FIG. 6). The pin 804 is also provided through openings in the gate 108 such that the gate 108 can rotate about the pin 804 relative to the end 802 of the pallet 100. The latch 806 is attached to the pallet 100 and includes a slot 810 configured to receive the notch 808, which is attached to the gate 108. The slot 810 runs lengthwise about the latch 806 and is configured to allow the notch 808 to traverse the latch 806 about the length of the slot 810. Thus, when the notch 808 traverses the latch 806 in a first direction, the gate 108 rotates about the pin 804 away from the end 802 of the pallet 100. Likewise, when the notch 808 traverses the latch 806 in the direction opposite the first direction, the gate 108 rotates about the pin 804 toward the end 802 of the pallet 100. In the embodiment shown in FIG. 8, for example, there is a locking position 812 at an end of the slot 810 that is configured to maintain the gate 108 in a position substantially parallel to the vertical plate 109 (as shown, for example, in FIG. 8). In certain embodiments, for example, hydraulic cylinders can be used in connection with raising and lowering such a gate.

In certain embodiments, for example, using end gates that are pivotal relative to a pallet can provide for better access to the bottom panel and/or side panels of the pallet, thereby allowing cleaning equipment improved access to such areas, for example. Such improved access can provide increased efficiency and/or reduce costs in a manufacturing environment.

FIG. 8 also depicts the counteracting forces of the strands 114 and the rods 202 on the pallet 100. In the embodiment shown in FIG. 8, for example, the strands 114 (when tensioned) provide a force on the pallet 100 in the direction x, and the rods 202 provide a force on the pallet 100 in the direction y, which is opposite to direction x.

In certain embodiments, for example, using a counter-tensioned pallet can allow for larger pallets to be movable about a manufacturing facility, thereby allowing larger pre-stressed concrete products to be fabricated in such an environment, which can provide increased efficiency and/or reduce costs, for example.

FIG. 8 also depicts a distance d between strands 114 and a height z that materials 814 can be added to the form. In the embodiment shown in FIG. 8, for example, an insert 816 is disposed within the concrete 818 between the strands 114. In certain embodiments, for example, the insert can be made of foam. In certain embodiments, for example, the insert can be made of other materials. In certain embodiments, for example, wire mesh can be disposed within the concrete 818 between a bottom strand 114 and a bottom surface of the concrete 818. In certain embodiments, for example, wire mesh can also be disposed within the concrete 818 between a top strand 114 and a top surface of the concrete 818.

Embodiments of the present technology also provide methods for fabricating pre-stressed concrete products. In certain embodiments, for example, the systems described above in connection with FIGS. 1-9 can be used in connection with such methods.

In an embodiment, for example, a method for fabricating pre-stressed concrete products using a pallet with a plurality of gates pivotally attached to the ends of the pallet can include: (1) securing each gate in a position that is substantially parallel to an end of the pallet; (2) securing end panels that include vertical plates to a bottom panel of the pallet, for example, using magnets, such that the vertical plates are substantially parallel to an end of the pallet and provide a form between themselves and side panels of the pallet; (3) securing side panels that include vertical plates to a bottom panel of the pallet, for example, using magnets, such that the vertical plates are substantially parallel to a side of the pallet and provide a form between themselves and the end panels; (4) providing a plurality of strands through a plurality of openings in a first gate; (5) securing the strands to the first gate, for example, using a plurality of chucks; (6) providing the strands through a corresponding plurality of openings in a first vertical plate; (7) providing the strands through a corresponding plurality of openings in a second vertical plate; (8) providing the strands through a corresponding plurality of openings in a second gate; (9) tensioning the strands by elongating the strands; (10) securing the strands to the second gate, for example, using a plurality of chucks; (11) removing excess strand material, for example, by cutting the strands beyond the end of the chucks; (12) providing wet concrete into the form; (13) providing wire mesh into the form; (14) providing more wet concrete into the form; (15) providing an insert, for example, a foam insert into the form; (16) providing more wet concrete into the form; (17) providing more wire mesh into the form; (18) providing more wet concrete into the form; (19) allowing the concrete to cure, for example, for eight hours; (20) removing the chucks; (21) pivoting each gate to a position that extends away from the nearest end of the pallet; (22) removing all vertical plates that are secured to the bottom panel of the pallet; (23) removing the concrete product from the form; and (24) cleaning the bottom and side panels of the pallet, for example, using manual labor and/or a cleaning machine(s).

In certain embodiments, for example, a method for fabricating pre-stressed concrete products can also include moving the pallet between a plurality of stations where one or more of the above-recited steps can be performed. For example, in certain embodiments, the pallet can be moved using rollers and/or lifts as described, for example, in connection with FIGS. 4 and 5.

In certain embodiments, for example, a method for fabricating pre-stressed concrete products can omit one or more of the steps recited above and/or perform the steps in a different order than the order listed. For example, some steps may not be performed in certain embodiments. As a further example, certain steps may be performed in a different temporal order, including simultaneously, than listed above.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A movable pallet for use in fabrication of a concrete product, the movable pallet comprising:
(a) a bottom panel including an upper surface;
(b) a first gate disposed at a first end of the bottom panel, wherein the first gate is configured to be movable between a first position, wherein the first gate extends vertically relative to the upper surface of the bottom panel, and a second position, wherein the first gate extends away from the first end of the bottom panel.

2. The movable pallet of claim 1, further comprising:
(c) a first side panel configured to extend vertically from the upper surface at a first side of the bottom panel; and
(d) a second side panel configured to extend vertically from the upper surface at a second side of the bottom panel.

3. The movable pallet of claim 2, wherein at least one of the first and second side panels are configured to be removably secured to the bottom panel.

4. The movable pallet of claim 1, further comprising:
(c) a first end panel configured to extend vertically from the upper surface at the first end of the bottom panel; and
(d) a second end panel configured to extend vertically from the upper surface at a second end of the bottom panel.

5. The movable pallet of claim 4, wherein at least one of the first and second end panels are configured to be removably secured to the bottom panel.

6. The movable pallet of claim 1, further comprising a strand, wherein the first gate is configured to receive the strand.

7. The movable pallet of claim 6, wherein the strand is configured to apply a force to the pallet.

8. The movable pallet of claim 6, further comprising a chuck, wherein the chuck is configured to secure the strand to the first gate.

9. The movable pallet of claim 1, further comprising:
(c) a rod configured to apply a force to the pallet.

10. The movable pallet of claim 9, wherein the rod is adjustable such that the amount of force applied by the rod to the pallet can be adjusted.

11. The movable pallet of claim 1, further comprising:
(c) a second a gate disposed at a second end of the bottom panel, wherein the second gate is configured to be movable between a first position, wherein the second gate extends vertically relative to the upper surface of the bottom panel, and a second position, wherein the gate extends away from the second end of the bottom panel.

12. The movable pallet of claim 11, further comprising:
(d) a strand configured to apply a force to the pallet; and
(e) a rod configured to apply a force to the pallet,
wherein the first and second gates are configured to receive the strand, and wherein the force applied by the rod counteracts the force applied by the strand.

13. A method for fabricating a pre-stressed concrete product comprising:
(a) securing a strand to a first gate;
(b) extending the strand through a form configured to receive concrete;
(c) elongating the strand;
(d) securing the strand to a second gate; and
(e) providing concrete into the form.

14. The method of claim 13, wherein the first gate is pivotally attached to a movable pallet.

15. The method of claim 13, further comprising:
(f) moving the form.

16. The method of claim 13, wherein the form comprises a bottom panel and an end panel configured to extend vertically from the bottom panel, wherein the end panel is removably attached to the bottom panel.

17. The method of claim 16, wherein extending the strand through the form includes passing the strand through an opening in the end panel.

18. The method of claim 13, wherein securing the strand to the first gate includes passing the strand through an opening in the first gate and securing the strand using a chuck.

19. The method of claim 13, further comprising pivoting the first gate relative to the form.

20. The method of claim 13, further comprising utilizing a rod to counteract a force applied to the form by the strand.
